(19) United States
(12) Patent Application Publication
(10) Pub. No.: US 2026/0330466 A1
(43) Pub. Date: Oct. 22, 2026

(54) METHOD FOR DISPLAYING BENEFIT INFORMATION AND ELECTRONIC DEVICE

(71) Applicant: Hangzhou Alibaba International Internet Industry Co., Ltd., Hangzhou City (CN)

(72) Inventor: Yang WANG, Hangzhou (CN)

(21) Appl. No.: 19/529,335

(22) Filed: Feb. 4, 2026

Related U.S. Application Data
(63) Continuation of application No. PCT/CN2024/104317, filed on Jul. 8, 2024.

(30) Foreign Application Priority Data
Aug. 14, 2023 (CN) 202311015911.7

(51) Int. Cl. G06Q 30/01

(52) U.S. Cl. CPC G06Q 30/01

(57) ABSTRACT

A method for displaying benefit information comprises: obtaining a benefit data definition template, the benefit data definition template including multiple data fields; obtaining data display rule information corresponding to each of multiple benefit items; saving, according to the benefit data definition template, data for a user on the multiple data fields of the multiple benefit items; and in response to a request from a target user to view benefit information, reading, from the saved information, the data of the target user on the multiple data fields of the multiple benefit items, and assembling the data into display content corresponding to each of the multiple benefit items, so as to display the display content corresponding to each of the multiple benefit items on a target page.

### CROSS-REFERENCE TO RELATED APPLICATIONS

This application is a Continuation Application of International Patent Application No. PCT/CN2024/104317, filed on Jul. 8, 2024, which is based on and claims priority to and benefits of Chinese Patent Application No. 202311015911.7, filed with the China National Intellectual Property Administration on Aug. 14, 2023, and titled “Method for Displaying Benefit Information and Electronic Device.” The entire content of above-referenced applications is incorporated herein by reference.

### TECHNICAL FIELD

The present application relates to the field of information technology, and more particularly, to a method for displaying benefit information and an electronic device.

### BACKGROUND

Many application systems have membership systems, where users can obtain more member benefits by becoming a higher-level member type. For example, in a product information service system, multiple different member types can be provided for merchant users. At a higher membership level, merchants can obtain multiple member benefits such as industry operation guidance, priority for high-quality logistics services, and so on.

In the prior art, information such as the benefits available at various membership levels is usually introduced to users by customer service personnel. However, after a user becomes a member of a corresponding level, information about the available benefits is usually revealed in multiple different scenarios. For example, when a merchant ships goods to an overseas user, the user may be prompted that they have “ocean freight priority,” and so on. It can be seen that, in this manner, the user's perception and use of various benefits are in a relatively passive state. Therefore, many benefits may be rarely used by users, or the frequency of use is very low, making it difficult to reflect the actual value that the corresponding membership level can bring to the user.

### SUMMARY

The present application provides a method for displaying benefit information and an electronic device, which can aggregate and display information of multiple different benefit items on the same page, and has low development costs and high scalability.

The present application provides the following solution:

A method for displaying benefit information, comprising:
obtaining a benefit data definition template, the benefit data definition template including multiple data fields, the multiple data fields including data fields related to basic information and data fields related to user usage status;
obtaining, for multiple benefit items respectively under different user usage statuses, corresponding data display rule information on the data fields related to user usage status;
saving, according to the benefit data definition template, data for a user on the multiple data fields of the multiple benefit items, wherein the data on the data fields related to user usage status is determined based on the user's benefit item user usage status information and the data display rule information;
in response to a request from a target user to view benefit information, reading, from the saved information, data of the target user on the multiple data fields of the multiple benefit items, and assembling the data into display content corresponding to each of the multiple benefit items, so as to display the display content corresponding to each of the multiple benefit items on a target page.

Here, for data fields related to user usage status, different benefit items correspond to different candidate values in the same field.

The data display rule information specifically comprises: a correspondence relationship between each candidate value of a same benefit item on a same field and a user usage status, so that based on usage status information of a specific user, the data to be displayed for the corresponding benefit item on the corresponding field is determined from among the candidate values of the corresponding benefit item on the corresponding field.

The data fields related to user usage status include: description text and/or action items to be displayed when displaying a benefit item.

The obtaining data display rule information on data fields related to user usage status, corresponding to multiple benefit items respectively under different user usage statuses, comprises:
obtaining description text and/or action item display rule information corresponding to multiple benefit items respectively under different user usage statuses; wherein each benefit item corresponds to a different candidate text and/or candidate action item, and the data display rule information comprises: a correspondence relationship between each candidate text and/or candidate action item of a same benefit item and a user usage status.

The saving, according to the benefit data definition template, data for multiple users on multiple data fields of multiple benefit items, comprises:
obtaining usage status information of multiple users for the multiple benefit items respectively, and based on the usage status information and the data display rules, determining the corresponding description text and/or action item to be displayed when displaying the benefit items to each user, and saving the determined description text and/or action item as data on the corresponding data fields.

The action item information includes a name and a jump address of an action item, so as to jump to a corresponding page according to the jump address to obtain detailed information related to the benefit item, or to perform processing related to the benefit item.

If the target user has used a benefit item, the description text includes: a number of times the target user has used the benefit item, a number of remaining uses, and/or information on a usage effect obtained.

If the target user has not used a benefit item, the description text comprises: summary information of a functional description of the benefit item.

Here, by executing a scheduled task, usage status information of multiple users for the multiple benefit items is acquired respectively, and based on the usage status information and the data display rule information, data on data fields corresponding to user usage status is determined when displaying the benefit items to each user.

The benefit data definition template comprises: a first template and a second template, wherein the first template is used for defining data fields related to basic information for the benefit item, and the second template is used for defining data fields related to user usage status for multiple benefit items.

The saving, according to the benefit data definition template, data for multiple users on multiple data fields of multiple benefit items, comprises:
according to the first template, saving data on the data fields of the multiple benefit items related to basic information as benefit configuration information;
according to the second template, saving data on the data fields of the multiple benefit items related to user usage status as benefit usage-related data information;
when responding to a request initiated by the target user to view benefit information, the method comprising:
obtaining, from the benefit configuration information, data of the multiple benefit items on the data fields related to basic information;
obtaining, from the benefit usage-related data, data of the target user for the multiple benefit items on the data fields related to user usage status;
assembling the data of the multiple benefit items on the data fields related to basic information and the data on the data fields related to user usage status to generate display content corresponding to each of the multiple benefit items.

The obtaining, from the benefit configuration information, the data of the multiple benefit items on the data fields related to basic information comprises:
determining membership type information corresponding to the target user;
obtaining, from the benefit configuration information, data of multiple benefit items corresponding to the membership type on the data fields related to basic information.

Here, different membership types correspond to different processor modules;
after determining the membership type information corresponding to the target user, the method further comprising:
determining a corresponding processor module based on the membership type information, so that the processor module performs reading and assembling processing of the data.

Here, the benefit configuration information comprises a sort index field corresponding to the benefit item;
the method further comprises:
sorting the display content corresponding to the multiple benefit items according to data on the sort index field, so that the display content is displayed on the target page in a corresponding order.

Here, when a benefit item is added, deleted, or its information is updated, the displayed benefit item and/or the corresponding display content is updated by updating the benefit configuration information and/or the benefit usage-related data information.

A method for displaying benefit information, comprising:
receiving a request initiated by a target user to view benefit information;
displaying a target page, the target page comprising display content corresponding to each of a plurality of benefit items, wherein the display content is generated after a same processor module reads data of the target user on multiple data fields of the multiple benefit items and assembles the data;
wherein the data of the target user on the multiple data fields of the multiple benefit items is determined according to a benefit data definition template, which comprises data fields related to basic information and data fields related to user usage status, and the data on the data fields related to user usage status is determined based on benefit item usage status information of the user and the data display rules.

The display content corresponding to each of the multiple benefit items comprises:
action item information corresponding to the benefit item, wherein the action item information includes a name and a jump address of an action item, so as to jump to a corresponding page according to the jump address to obtain detailed information related to the benefit item, or to perform processing related to the benefit item;
wherein different benefit items correspond to different action items under a same user usage status.

A device for displaying benefit information, comprising:
a template acquisition unit, configured to acquire a benefit data definition template, wherein the benefit data definition template includes a plurality of data fields, and the plurality of data fields include data fields related to basic information and data fields related to a user usage status;
a data display rule acquisition unit, configured to acquire data display rule information on data fields related to a user usage status corresponding to a plurality of benefit items respectively under different user usage statuses;
a data acquisition unit, configured to save, according to the benefit data definition template, data of a user on a plurality of data fields of a plurality of benefit items, wherein the data on the data fields related to the user usage status is determined according to user's benefit item usage status information and the data display rules;
a display content construction unit, configured to, in response to a request initiated by a target user to view benefit information, read data of the target user on the plurality of data fields of the plurality of benefit items from the saved information, and assemble the data into display content respectively corresponding to the plurality of benefit items, so as to display the display content respectively corresponding to the plurality of benefit items in a target page.

A device for displaying benefit information, comprising:
a request receiving unit, configured to receive a request initiated by a target user to view benefit information;
a page display unit, configured to display a target page, wherein the target page includes display content respectively corresponding to a plurality of benefit items, and the display content is generated after a same processor module reads and assembles data of the target user on a plurality of data fields of the plurality of benefit items;
wherein the data of the target user on the multiple data fields of the multiple benefit items is determined according to a benefit data definition template, which comprises data fields related to basic information and data fields related to user usage status, and the data on the data fields related to user usage status is determined based on benefit item usage status information of the user and the data display rules.

A computer-readable storage medium, on which a computer program is stored, wherein the program, when executed by a processor, implements the steps of the method according to any one of the preceding items.

An electronic device, comprising:
one or more processors; and
a memory associated with the one or more processors, the memory being configured to store program instructions, wherein the program instructions, when read and executed by the one or more processors, execute the steps of the method according to any one of the preceding items.

According to specific embodiments provided by the present application discloses the following technical effects:

Through the embodiments of the present application, the display information of multiple different benefit items can be decomposed in a standardized manner and extracted into a standardized template. In the template, the data to be displayed corresponding to a benefit item can be split into data fields related to basic information and data fields related to user usage status. At the same time, data display rules on the fields related to user usage status can be configured for multiple benefit items respectively under different user usage statuses. Afterward, according to the benefit data definition template, data for a user on the multiple data fields of the multiple benefit items can be saved. The data on the fields related to user usage status can be determined based on the user's usage status information of the multiple benefit items and the aforementioned data display rules. In this way, after a target user initiates a request to view benefit information, the data of the target user on the multiple data fields of the multiple benefit items can be read from the saved information and assembled into display content corresponding to each of the multiple benefit items for display on a target page. Through this method, information of multiple different benefit items can be aggregated and displayed on the same page, and information related to user usage status can also be displayed. During implementation, although the information to be revealed for each benefit item in the same field may be different and is related to the specific user's usage status of the corresponding benefit item, because the data fields corresponding to each benefit item are uniformly defined, and the data to be displayed for different users in the multiple fields of each benefit item can be obtained in advance, the same processing logic can be used to process and complete the data assembly when it is necessary to display to the user. Correspondingly, only one set of processing logic needs to be developed to complete the display of multiple different benefit items, thereby achieving the purpose of reducing development costs.

In addition, when a benefit item is added, deleted, or its information is updated, only the specific configuration information needs to be updated. For example, for a newly added benefit item, it is only necessary to configure the data on each field according to the aforementioned template, without needing to separately develop new processing logic. Therefore, the solution has stronger scalability.

In a preferred implementation, the relevant data of a benefit item can also be decomposed into two parts: data on fields related to basic information, and data on fields related to user usage status, and a first template and a second template can be provided correspondingly. In this way, it is only necessary to save and dynamically update the data on the fields related to user usage status at the user dimension. As for the data on the fields related to basic information, it is only necessary to save one copy for each benefit item, and it is not necessary to save a separate copy for each user, thereby saving storage space.

Of course, any product implementing the present application does not necessarily need to achieve all the above-mentioned advantages simultaneously.

### BRIEF DESCRIPTION OF THE DRAWINGS

To describe the technical solutions in the embodiments of the present application or in the prior art more clearly, the accompanying drawings required for describing the embodiments are briefly introduced below. Obviously, the accompanying drawings in the following description are only some embodiments of the present application. For a person of ordinary skill in the art, other drawings may be obtained from these accompanying drawings without creative efforts.

FIG. 1 is a schematic diagram of a system architecture provided by an embodiment of the present application;

FIG. 2 is a flowchart of a first method provided by an embodiment of the present application;

FIG. 3 is a schematic diagram of a first interface provided by an embodiment of the present application;

FIG. 4 is a schematic diagram of a second interface provided by an embodiment of the present application;

FIG. 5 is a schematic diagram of a third interface provided by an embodiment of the present application;

FIG. 6 is a flowchart of a second method provided by an embodiment of the present application;

FIG. 7 is a schematic diagram of a first apparatus provided by an embodiment of the present application;

FIG. 8 is a schematic diagram of a second apparatus provided by an embodiment of the present application;

FIG. 9 is a schematic diagram of an electronic device provided by an embodiment of the present application.

### DETAILED DESCRIPTION OF THE EMBODIMENTS

The technical solutions in the embodiments of the present application will be described clearly and completely below with reference to the accompanying drawings in the embodiments of the present application. Obviously, the described embodiments are only a part of the embodiments of the present application, not all of the embodiments. Based on the embodiments in the present application, all other embodiments obtained by a person of ordinary skill in the art without creative efforts shall fall within the protection scope of the present application.

First, it should be noted that the inventor of the present application found during the implementation of the embodiments of the present application that, in the prior art, a dedicated page is usually not provided to display which benefits can be enjoyed under a specific member type. Instead, they are scattered across different pages. If a user (specifically, a merchant user) needs to use or enable (including activating, configuring, authenticating, etc.) a certain benefit, they need to find the entry point for operations such as using or enabling the corresponding benefit through a multi-level directory, and only then can they perform the corresponding operation.

In view of the above situation, to better provide users with information about benefits and facilitate users' use of specific benefits, in the embodiments of the present application, a specific page can be provided to the user. On this page, information about multiple available benefits included under a specific member type can be aggregated and displayed. Moreover, not only can basic information such as the name and introduction of each benefit be displayed, but also information related to user usage status, such as corresponding description text (e.g., whether it has been used, if so, what the effect was, etc.) and related action item information, can be provided based on the specific user's usage status of each benefit. In this way, users can learn from the same page what benefit items they have, whether they have used them, and if so, the corresponding usage effects and other information. In addition, they can also take specific actions directly through this page, for example, including using, activating, or signing up for a certain benefit item, etc., without having to go to different pages to find the corresponding action entry points.

However, the inventor of the present application found during the implementation of the above solution that, for different users, because their usage of each benefit item is different, the corresponding text, action items, etc. that need to be displayed will also be different. For example, if a user has already used a certain benefit item, it means that the preliminary processes such as activation and authentication have been completed, and it can be used directly. Therefore, action items such as “Go to Use” can be provided directly. If a user has not yet used a certain benefit item, they may need to first perform processes such as activation and authentication. Therefore, options such as “Go to Activate” and “Go to Authenticate” can be displayed. On the other hand, for different benefit items, even with the same user usage status, the specific text and action items that need to be revealed to the user may be different. For example, for benefit items A and B, a certain user has already used both benefits. However, for benefit item A, the text to be displayed may be “X goals to be completed,” while for benefit item B, the text to be displayed may be “X reported this month,” and so on, where “X” needs to be determined based on the specific user's usage. Alternatively, for benefit items C and D, a certain user has not used either of them. However, the action item to be displayed to the user for benefit item C may be “Go to Sign Up,” while the action item to be displayed to the user for benefit item D may be “Go to Verify,” and so on.

That is to say, if it is necessary to display multiple different benefit items and their corresponding user-usage-related data/action items on a unified page, then because the information/action points that each benefit item needs to reveal to the user are different, and the specific description text and action items included may also be different, the situation is relatively complex, and the issue of how to implement it needs to be considered.

For example, a specific implementation may be: it is necessary to separately define a processing class (which may also be called a processor module) for each benefit item to undertake the processing logic for each type of benefit, including obtaining, processing, and handling the data for each benefit item, etc. However, since it is necessary to separately define processors for a plurality of different benefit items, and each processor needs to output description text such as a benefit item name, an icon, whether a standard is met, a benefit description text, N remaining benefits, etc., and also needs to output different action items, the development cost will be relatively high when the number of benefit items is relatively large; in addition, each time a new benefit item is added, a benefit processing class needs to be redefined, and therefore, the scalability of the solution will also be relatively poor.

To reduce development costs and improve the scalability of the solution, in the embodiments of the present application, a specific solution is also provided. In this solution, a unified processing class can be developed for multiple different benefit items to meet the differentiated needs of different benefit items in terms of display text and action items through the same processing logic. To achieve this purpose, the embodiments of the present application can first provide a standardized benefit data definition template. In this template, multiple specific data fields can be defined. Different benefit items can share this unified template when being displayed. That is, the specific display content of each benefit item can be assembled from the data in each field of the specific template.

After the data definition template is configured, the data of each benefit item in each field can be configured at the user dimension according to this template, to be used for assembling specific display content. As mentioned above, because different benefit items may have different requirements when revealing information related to user usage, such as description text and action items, even under the same user usage status, respective display rules can also be configured for each benefit item. These display rules mainly refer to the data display rule information on the data fields related to user usage status, corresponding to each of the multiple benefit items under different user usage statuses. For example, because for fields related to user usage status, different benefit items correspond to different candidate values in the same field, the specific data display rule information can be the correspondence between the candidate values of the same benefit item in the same field and the user usage status. In this way, based on the specific user's usage status information, the data to be displayed for the corresponding benefit item in the corresponding field can be determined from the candidate values of the corresponding benefit item in the corresponding field, and so on.

After the specific benefit data definition template and the aforementioned data display rule information are configured, because they include data fields related to the user's usage of benefit items, and this data may change continuously, in a preferred implementation, a scheduled task can be executed to obtain user-dimension data related to benefit item usage from a corresponding data source (e.g., a base data table that maintains user-dimension feature data, such as the number of uses of a certain benefit item). This includes whether a user has used a certain benefit item, the specific usage effect, and so on. After obtaining this data, based on the display rule information corresponding to the specific benefit item, it can be determined what specific text and which specific action item need to be displayed when displaying the specific benefit item to the user, and so on. This data can be saved in the form of a vertical table or the like, and be updated periodically by the aforementioned scheduled task.

Since the data of each benefit item in multiple fields is maintained at the user dimension, when a specific target user needs to access a specific page such as a benefits center, the basic information of the specific benefit item and the data on the fields related to user usage can be read from the pre-saved data and assembled into specific display content for display on the page. Since the data fields in the above template are uniformly defined, although the content displayed for each benefit item in each field may be different, the same processing logic can be used to process and complete the data assembly when it is necessary to display to the user. Therefore, only a unified processor module needs to be developed to complete the display of various different benefit items, thereby achieving the purpose of reducing development costs. In addition, when adding a new benefit item, it is only necessary to configure or obtain the data on each field according to the aforementioned template, without needing to separately develop new processing logic. Therefore, the solution has stronger scalability. Of course, in practical applications, different processor modules can also be developed according to different member types, so that the same processor module can process and assemble the relevant data of multiple different benefit items corresponding to the same member type.

In a preferred embodiment, since specific benefit data may include some fields where the specific data is relatively fixed and does not change due to different users or different user usage statuses, for example, basic information such as the name and icon of a benefit item, the specific benefit data definition template can also be split into two parts, which are used to standardize the definition of fields related to the basic information of the benefit item and fields related to the user usage status, respectively. In this way, it is possible for a plurality of users to share the same set of basic information about each benefit item, and only the data related to the user usage status needs to be dynamically constructed and saved separately on a per-user basis. This can avoid storing the basic information of each benefit item separately for each user, thereby saving storage space.

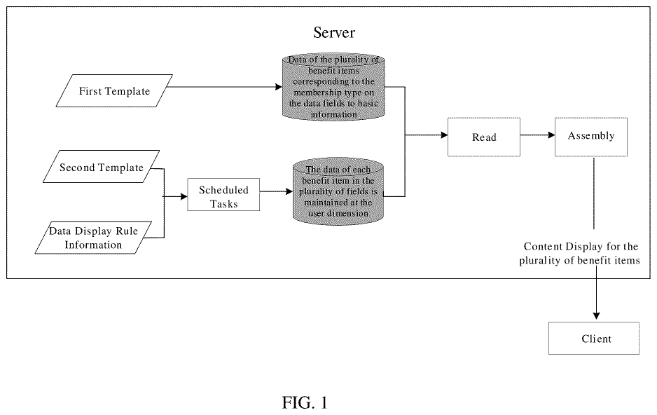

From a system architecture perspective, referring to FIG. 1, an embodiment of the present application may involve a client and a server of a specific application system. On the server, a specific benefit data definition template may be mainly stored (which may specifically include a first template corresponding to basic information fields and a second template corresponding to fields related to user usage). In addition, data display rule information on fields related to user usage, corresponding to multiple benefit items under different user usage situations, may also be stored. Subsequently, data of each benefit item on the basic information fields may be obtained and stored. Data of user-dimension benefit items on fields related to user usage may also be constructed by executing scheduled tasks, etc., and may be updated regularly. After a specific user initiates a request to view benefit information through the client, the server may also read the data corresponding to the target user under each benefit item and assemble it into specific display content to be provided to the client for display.

The specific implementation solutions provided by the embodiments of the present application are described in detail below.

### Embodiment 1

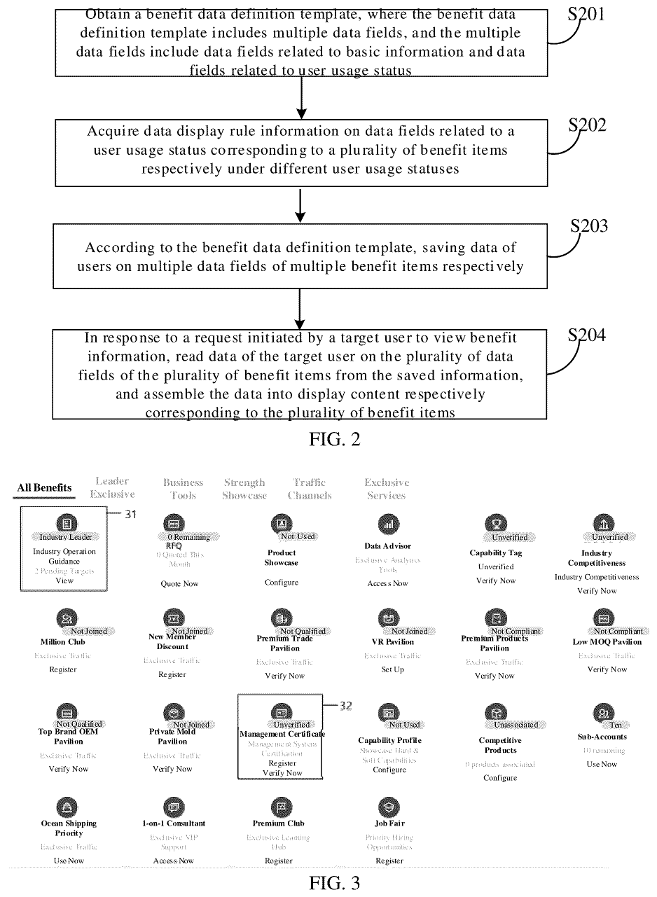

First, this first embodiment, from a server's perspective, provides a method for displaying benefit information. Referring to FIG. 2, the method may specifically include:

S201: Obtain a benefit data definition template, where the benefit data definition template includes multiple data fields, and the multiple data fields include data fields related to basic information and data fields related to user usage status.

The specific benefit data definition template can be specifically used to define a plurality of data fields, and the data in these data fields can be relevant data used to construct the display content of a specific benefit item. For example, the specific data fields can include the name, icon, text, action item information, etc., of the benefit item.

As described above, regarding the plurality of data fields in the specific template, some fields may be included where the specific data is relatively fixed and usually does not change due to different target users or different user usage statuses. These fields are usually used to define some basic information of a specific benefit item, for example, including the name, icon, etc., of the benefit item. In addition, there will be some fields that are related to the user usage status, that is, what kind of data needs to be revealed in the corresponding fields is dynamically changed according to the user's usage of the specific benefit item, for example, the text to be displayed, the name of the action item, etc.

Therefore, in a specific implementation, to save storage space, the specific benefit data definition template can also be split in a standardized way into a first template and a second template. The first template is mainly used to define fields related to some relatively fixed basic information, while the second template is mainly used to define some fields related to the user usage status. In this way, for different users, the first template can be universal, that is, for each benefit item, it is only necessary to maintain a unified set of configuration data according to the first template, which includes the name, icon, etc., of the benefit item (since the data in these fields will not change due to different users or different user usage statuses, it is not necessary to configure a separate copy for each user). As for the fields related to the user usage status, that is, fields where the specific data may change due to different user usage statuses, a separate copy of benefit data can be maintained for each user and saved by constructing a vertical table or the like.

For example, in a specific implementation, the first template may specifically include the fields shown in Table 1 below:

TABLE 1

| Field Name | Type | Remarks |
|---|---|---|
| index | int | Sort index |
| rightKey | String | Benefit code |
| rightNameMdsKey | String | Benefit name |
| | | multilingual key |
| rightGroupMdsKey | String | Benefit group |
| | | multilingual key |
| rightIcon | String | Benefit icon |
| rightIconDescType | String | Benefit icon description |
| | | display type |
| isDefaultShow | String | Whether to display by |
| | | default |
| isShow | String | Whether to display |
| | | externally |
| newRight | String | New benefit identifier |

Regarding the second template, the specifically defined data fields can be as shown in Table 2:

TABLE 2

| Field Name | Type | Remarks |
|---|---|---|
| user_id | Long | User ID |
| member_type | String | Member type |
| current_value | String | Current benefit display data |
| | | value |
| right_icon_desc | String | Benefit icon description |
| right_status | String | Benefit usage status |
| right_description_value | String | Data value in benefit |
| | | description text |
| right_description | String | Benefit description |
| | | multilingual key |
| right_action | String | Benefit action item |
| | | multilingual key |
| right_action_url | String | Benefit action item URL |

It should be noted here that in application systems involving cross-border scenarios, specific users may come from a plurality of different countries/regions. Therefore, when obtaining information such as the name, group, and description text of each benefit item, the issue of multilingual display may be involved. Specifically, for this type of basic information, the data for each benefit item under each field can be saved in a plurality of different languages. When displaying to a specific user, the benefit item name, etc., in the corresponding language can be selected for display based on the country/region where the user is located, etc.

S202: Obtain data display rule information on data fields related to a user usage status corresponding to a plurality of benefit items respectively under different user usage statuses.

Since for data fields related to the user usage status, different benefit items may correspond to different candidate values in the same field, even under the same user usage status, the specific data that needs to be revealed for different benefit items may also be different. For example, when different benefit items are for the same user usage status, the data on fields related to the user usage status, such as the specific text or action item to be revealed, may also be different. Therefore, specific data display rule information can also be configured for each benefit item. For example, this data display rule can be used to describe which candidate values each benefit item has in the specific fields related to the user usage status, and what kind of data needs to be revealed in specific fields under various different user usage statuses, for example, including what kind of description text and/or what kind of action item to specifically reveal, etc. The specific candidate text, action items, and corresponding reveal rules for each benefit item can all be different.

For example, the candidate action items corresponding to a certain benefit item A are “Go to use”, “Go to activate”, etc., while the candidate action items corresponding to another benefit item B are “Go to use”, “Go to certify”, etc.; accordingly, the corresponding rules can be set as follows:
Benefit item A:
If the user has used the benefit item A, the displayed action item is “Go to use”; if the user has not used the benefit item A, since the benefit item A needs to be activated before use, the displayed action item can be “Go to activate”;
Benefit item B:
If the user has used the benefit item B, the displayed action item is “Go to use”; if the user has not used the benefit item B, since the user needs to be certified before using the benefit item B, the displayed action item can be “Go to certify”.

It should be noted that in the specific display rules, regarding action items, in addition to configuring the name of the action item, information such as the jump address corresponding to the specific action item can also be configured. This facilitates jumping to the corresponding page for display via the jump address if the user clicks the specific action item after it is displayed, so as to facilitate the user in completing the corresponding “action”.

Regarding the specific description text, it can also be configured differently according to different user usage statuses. For example, if the target user has used the benefit item, the description text comprises: the number of times the target user has used the benefit item, the remaining number of times, and/or information on usage effects obtained, etc. If the target user has not used the benefit item, the description text comprises: summary information of a functional description of the benefit item, etc. In addition, under the same user usage status, the description text required to be revealed for different benefit items can be different. For example, if a user has used two benefit items, the text to be revealed for one benefit item may be “X goals to be completed”, while the text to be revealed for the other benefit item may be “X reported this month”, etc. These can all be configured by means of rules, where the specific quantity information can be dynamically determined based on the actual usage status of the specific user.

S203: according to the benefit data definition template, saving data of users on multiple data fields of multiple benefit items respectively, where the data on the data fields related to user usage status is determined based on the user's benefit item usage status information and the data display rule information.

Since the benefit data definition template and data display rules are configured, data for a plurality of users on a plurality of data fields of a plurality of benefit items can be saved according to the template and the data display rules. If split into the first template and the second template, for the first template part, data on each data field can be configured for each benefit item. This data usually does not need to be updated unless the name, icon, etc., of a certain benefit item changes. That is, for data on fields related to the basic information of benefit items, it can be constructed through manual configuration or the like. For example, the specific benefit configuration item definition can be designed using a format such as JSON (JavaScript Object Notation). After the data configuration on the fields related to the basic information of each benefit item is completed, it can be saved on the server side, for example, through a configuration center server on the server side, etc.

For data on fields related to the user usage status, it can be specifically determined according to the user's benefit item usage status information and the data display rules. In a specific implementation, since each user's usage of a benefit item may change dynamically, the data on fields related to the user usage status may also change dynamically. To this end, in a preferred embodiment, the acquisition and periodic update of data on such fields related to user usage status can be performed by executing a scheduled task. In a specific implementation, data on the user's usage of each benefit item can be acquired from a data source such as a base data table that maintains user-dimension feature data. The above-mentioned base data table can be maintained by a log system or the like.

The acquired data on the user's usage of each benefit item may specifically include whether the user has used a certain benefit item, the specific number of uses of a certain benefit item, etc. This data can be directly acquired from the aforementioned base data table, or it can be obtained by processing the data in the base data table, etc. That is, if there are processed data metrics in the base data table, they can be used directly. If not, the aforementioned scheduled task can also process the data in the base table to obtain user usage data metrics for the benefit item. For example, for a certain benefit item, it is necessary to acquire whether a user has participated in a certain activity, but this data does not directly exist in the base data table. In this case, the scheduled task can use the existing data in the base data table to compile statistics on whether the user has participated in the activity, etc. The specific scheduled task can implement the logic for processing the data in the base table through means such as SQL (Structured Query Language) statements.

After determining the user's usage data for a benefit item, what information needs to be revealed in the fields related to user usage status when displaying the specific benefit item to the user can be determined according to the aforementioned display rule information corresponding to the specific benefit item, for example, including specific description text, action items, etc. For example, suppose a user has used a certain benefit item A, which is related to quoting and has a usage limit, the revealed text could be “X quotes made this month”, and the action item could be “Go to quote”, etc. The specific number of quotes made, “X”, can also be acquired by the aforementioned scheduled task from the specific base data table (acquired directly or after processing).

After obtaining the data related to the user's usage of a specific benefit item and determining the information to be displayed in the specific fields related to the user usage status when facing a specific user according to the data display rules corresponding to each benefit item, a user-dimension benefit item data table can be constructed (for example, it can be saved in the form of a vertical table). This data table can include benefit item data constructed for each user, for example, including description text determined according to each user's usage of each benefit item (whether it has been used, what the usage effect is, etc.), and can also include action item information to be displayed that is determined according to each user's usage of each benefit item, etc.

S204: In response to a request initiated by a target user to view benefit information, read data of the target user on the plurality of data fields of the plurality of benefit items from the saved information, and assemble the data into display content respectively corresponding to the plurality of benefit items, so as to display the display content respectively corresponding to the plurality of benefit items in a target page.

Since the data to be displayed in each field for the user-dimension benefit items has been acquired in advance, when it is necessary to display benefit information to a specific target user, the data of the target user on the plurality of data fields of the plurality of benefit items can be read from the already saved data and assembled into display content respectively corresponding to the plurality of benefit items.

If the split into two parts is made according to the aforementioned first template and second template, data of the plurality of benefit items on the data fields related to basic information can first be acquired from the benefit configuration information, and data of the target user on the data fields related to the user usage status for the plurality of benefit items can be acquired from the benefit usage-related data; then, the data of the plurality of benefit items on the data fields related to basic information and the data on the data fields related to the user usage status are assembled to generate the display content respectively corresponding to the plurality of benefit items.

It should be noted that the specific benefit configuration information may also include a sort index field corresponding to the benefit item, and the data in this field may include a sort position number of the specific benefit item, etc. At this time, the display content corresponding to the plurality of benefit items can also be sorted according to the data in the sort index field, so as to be displayed in the corresponding order on the target page.

For example, specifically during display, as shown in FIG. 3, information of each benefit item corresponding to the current target user may be displayed. For the benefit item shown at 31, its name is “Industry Operation Guidance”. Since the current target user has already used this benefit item, the displayed text is “2 goals to be completed” (where the number “2” can be dynamically changed to prompt the user about the usage of this benefit item), and the action item is “Go to view”. For the benefit item shown at 32, its name is “Management Certificate”. Since the current target user has not yet used this benefit item, the displayed text is “Management System Certificate”, and the action item may be “Go to verify”, and so on.

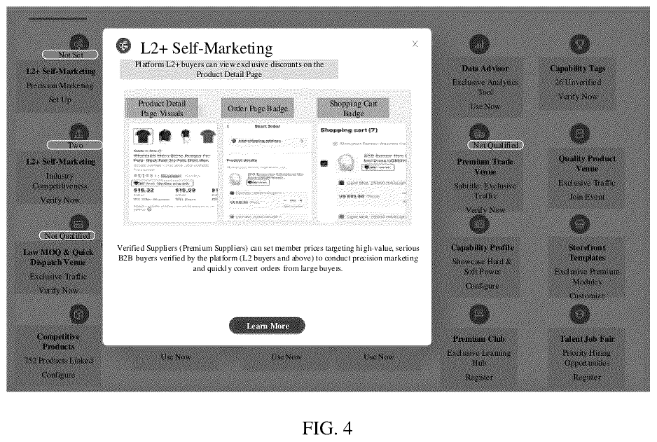

In addition, icons of specific benefit items may also be in an interactive state. When an interactive operation such as a click is performed, some detailed descriptive information of the benefit item may be displayed through a pop-up window/floating layer, etc. For example, when clicking the icon of the “L2+ Self-Marketing” benefit item, a pop-up window as shown in FIG. 4 may be displayed, where more detailed introductory information about this benefit item may be displayed. When clicking the “RFQ” benefit item, a pop-up window as shown in FIG. 5 may be displayed, where related information such as a detailed introduction of this benefit item may be displayed, and so on.

In addition, when a benefit item is added, deleted, or its data is updated, only the configuration information needs to be updated. For example, in the case of adding a new benefit item, it is only necessary to configure the data on each field for the new benefit item according to the aforementioned template, without needing to separately develop new processing logic. Therefore, this solution has stronger scalability.

It should also be noted that, in the embodiments of the present application, multiple benefit items can share the same processing logic for display. However, in a specific application system, there may be multiple different member types, and the available benefit items corresponding to different member types may be different. In addition, there may be some benefit items that have special requirements when being displayed, and so on. Therefore, in a specific implementation, different processing logic can also be implemented for different member types. In this way, when displaying benefit items for a target user, it is possible to first determine which member type the current target user belongs to, and then call the processing logic corresponding to that type for processing.

In summary, through the embodiments of the present application, the display information of multiple different benefit items can be decomposed in a standardized manner and extracted into a standardized template. In the template, the data to be displayed corresponding to a benefit item can be split into data fields related to basic information and data fields related to user usage status. At the same time, data display rules on the fields related to user usage status can be configured for multiple benefit items respectively under different user usage statuses. Afterward, according to the benefit data definition template, data for a user on the multiple data fields of the multiple benefit items can be saved. The data on the fields related to user usage status can be determined based on the user's usage status information of the multiple benefit items and the aforementioned data display rules. In this way, after a target user initiates a request to view benefit information, the data of the target user on the multiple data fields of the multiple benefit items can be read from the saved information and assembled into display content corresponding to each of the multiple benefit items for display on a target page. Through this method, information of multiple different benefit items can be aggregated and displayed on the same page, and information related to user usage status can also be displayed. During implementation, although the information to be revealed for each benefit item in the same field may be different and is related to the specific user's usage status of the corresponding benefit item, because the data fields corresponding to each benefit item are uniformly defined, and the data to be displayed for different users in the multiple fields of each benefit item can be obtained in advance, the same processing logic can be used to process and complete the data assembly when it is necessary to display to the user. Correspondingly, only one set of processing logic needs to be developed to complete the display of multiple different benefit items, thereby achieving the purpose of reducing development costs.

In addition, when a benefit item is added, deleted, or its information is updated, only the specific configuration information needs to be updated. For example, for a newly added benefit item, it is only necessary to configure the data on each field according to the aforementioned template, without needing to separately develop new processing logic. Therefore, the solution has better scalability.

In a preferred implementation, not only can the relevant data of a benefit item be decomposed into two parts, namely, data on fields related to basic information and data on fields related to user usage status, but a first template and a second template can also be provided correspondingly. In this way, it is only necessary to save and dynamically update the data on the fields related to user usage status at the user dimension. As for the data on the fields related to basic information, it is only necessary to save one copy for each benefit item, and it is not necessary to save a separate copy for each user, thereby saving storage space.

### Embodiment 2

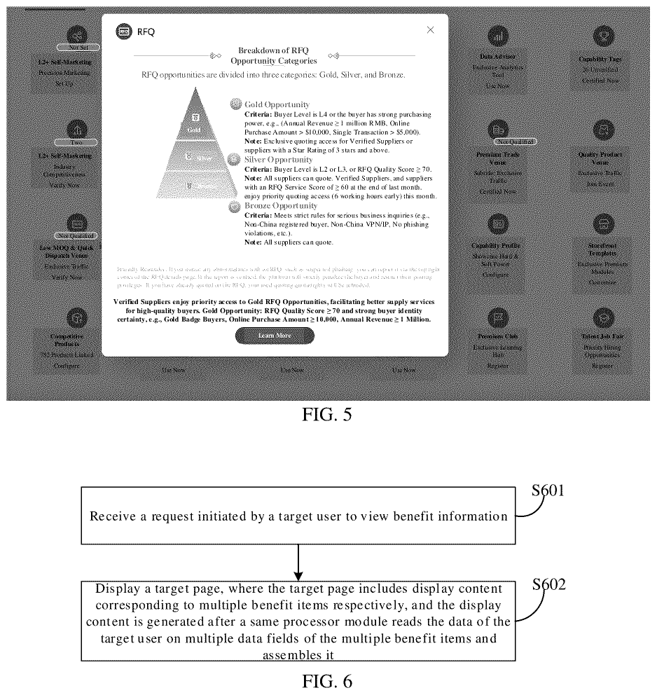

This second embodiment corresponds to the first embodiment and, from a client's perspective, provides a method for displaying benefit information. Referring to FIG. 6, the method may include:
S601: Receive a request initiated by a target user to view benefit information;
S602: Display a target page, where the target page includes display content corresponding to multiple benefit items respectively, and the display content is generated after a same processor module reads the data of the target user on multiple data fields of the multiple benefit items and assembles it;
here, the data of the target user on the multiple data fields of the multiple benefit items is determined according to a benefit data definition template, which comprises data fields related to basic information and data fields related to user usage status, and the data on the data fields related to user usage status is determined based on benefit item usage status information of the user and the data display rules.

Specifically, the display content respectively corresponding to the plurality of benefit items includes: action item information corresponding to the benefit item, where the action item information includes a name and a jump address of an action item, so as to jump to a corresponding page according to the jump address to obtain detailed information related to the benefit item, or to perform processing related to the benefit item; where different benefit items correspond to different action items under a same user usage status.

For details not described in this Embodiment 2, reference can be made to the descriptions in Embodiment 1 and other parts of this specification, which will not be repeated here.

It should be noted that the embodiments of the present application may involve the use of user data. In practical applications, under the condition of complying with the requirements of applicable laws and regulations of the host country (e.g., with explicit user consent, effective notification to the user, etc.), user-specific personal data may be used in the solutions described herein within the scope permitted by applicable laws and regulations.

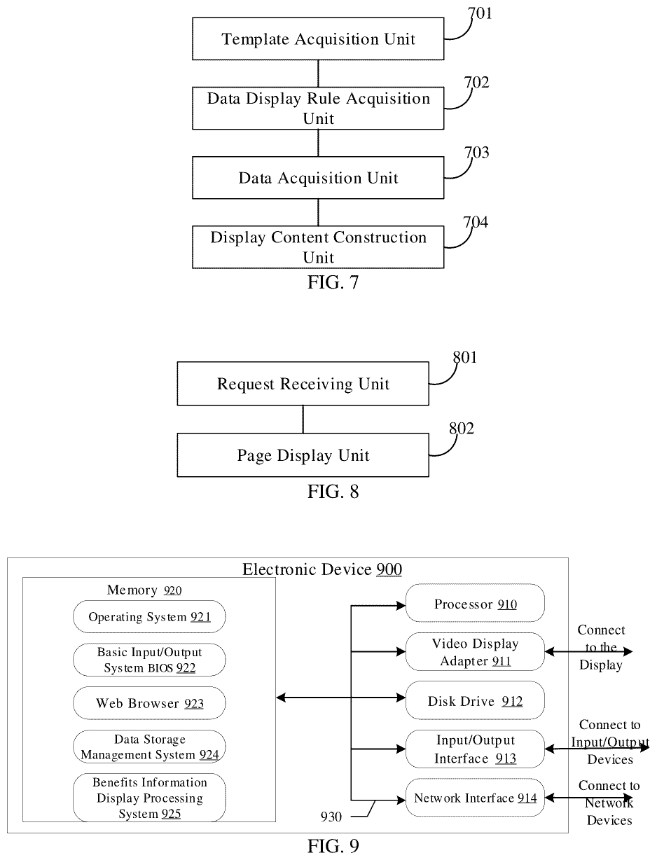

Corresponding to the first embodiment, an embodiment of the present application also provides an apparatus for displaying benefit information. Referring to FIG. 7, the apparatus may include:

a template acquisition unit 701, configured to obtain a benefit data definition template, where the benefit data definition template includes multiple data fields, and the multiple data fields include data fields related to basic information and data fields related to user usage status;
a data display rule acquisition unit 702, configured to obtain data display rule information on data fields related to user usage status, corresponding to multiple benefit items under different user usage situations respectively;
a data acquisition unit 703, configured to store, according to the benefit data definition template, data of users on multiple data fields of multiple benefit items respectively, where the data on the data fields related to user usage status is determined based on user's benefit item usage status information and the data display rules;
a display content construction unit 704, configured to, in response to a request initiated by a target user to view benefit information, read the data of the target user on the multiple data fields of the multiple benefit items from the stored information, and assemble it into display content corresponding to the multiple benefit items respectively, so that the display content corresponding to the multiple benefit items respectively can be displayed on a target page.

Here, the fields related to user usage status include: description text and/or action items to be displayed when displaying a benefit item;
in this case, the data display rule acquisition unit may be specifically configured to: obtain description text and/or action item display rule information corresponding to multiple benefit items under different user usage statuses respectively; where each benefit item corresponds to different candidate text and/or candidate action items, and the data display rule information includes: a correspondence relationship between each candidate text and/or candidate action item of a same benefit item and the user usage status;
the data acquisition unit may be specifically configured to: obtain usage status information of multiple users for the multiple benefit items respectively, and based on the usage status information and the data display rules, determine the description text and/or action items to be displayed when displaying the benefit items to each user, and store them as data on corresponding data fields.

The action item information includes a name and a jump address of an action item, so as to jump to a corresponding page according to the jump address to obtain detailed information related to the benefit item, or to perform processing related to the benefit item.

If the target user has used the benefit item, the description text comprises: a number of times the target user has used the benefit item, a remaining number of times, and/or obtained usage effect information.

If the target user has not used the benefit item, the description text comprises: summary information of a functional description of the benefit item.

Here, the data acquisition unit can specifically, by executing a scheduled task, acquire usage status information of multiple users for the multiple benefit items respectively, and based on the usage status information and the data display rules, determine data on data fields corresponding to user usage status when displaying the benefit items to each user.

Here, the benefit data definition template comprises: a first template and a second template, where the first template is used for defining data fields related to basic information for the benefit item, and the second template is used for defining data fields related to user usage status for multiple benefit items;
in this case, the data acquisition unit can be specifically used for:
according to the first template, saving data on the data fields of the multiple benefit items related to the basic information as benefit configuration information;
according to the second template, saving data on the data fields of the multiple benefit items related to user usage status as benefit usage-related data information;
The display content assembly unit can be specifically used for:
in response to a request initiated by the target user to view benefit information, obtaining, from the benefit configuration information, the data of the multiple benefit items on the data fields related to basic information;
obtaining, from the benefit usage-related data, data of the target user for the multiple benefit items on the data fields related to user usage status;
assembling the data of the multiple benefit items on the data fields related to basic information and the data on the data fields related to user usage status to generate display content corresponding to each of the multiple benefit items.

Specifically, if multiple different membership types exist, the display content assembly unit can be specifically used for: determining the membership type information corresponding to the target user; and obtaining, from the benefit configuration information, the data of multiple benefit items corresponding to the membership type on the data fields related to basic information.

In addition, different membership types can also correspond to different processor modules, and in this case, the display content assembly unit can also be specifically used for: after determining the membership type information corresponding to the target user, determining a corresponding processor module based on the membership type information, so that the processor module performs the data reading and assembly processing.

Here, the benefit configuration information can also comprise a sort index field corresponding to the benefit item;
in this case, the device can also comprise:

a sorting unit, used for sorting the display content corresponding to the multiple benefit items according to data on the sort index field, so as to display on the target page in a corresponding order.

Here, when a benefit item is added, deleted, or its information is updated, the displayed benefit item and/or the corresponding display content is updated by updating the benefit configuration information and/or the benefit usage-related data information.

Corresponding to the second embodiment, an embodiment of the present application also provides an apparatus for displaying benefit information. Referring to FIG. 8, the apparatus may include:
a request receiving unit 801, configured to receive a request initiated by a target user to view benefit information;
a page display unit 802, configured to display a target page, where the target page includes display content corresponding to multiple benefit items respectively, and the display content is generated after a same processor module reads the data of the target user on multiple data fields of the multiple benefit items and assembles it;
here, the data of the target user on the multiple data fields of the multiple benefit items is determined according to a benefit data definition template, which comprises data fields related to basic information and data fields related to user usage status, and the data on the data fields related to user usage status is determined based on benefit item usage status information of the user and the data display rules.

The display content corresponding to the multiple benefit items respectively includes:
action item information corresponding to the benefit item, where the action item information includes a name and a jump address of an action item, so as to jump to a corresponding page according to the jump address to obtain detailed information related to the benefit item, or to perform processing related to the benefit item; where different benefit items correspond to different action items under a same user usage status.

In addition, an embodiment of the present application also provides a computer-readable storage medium on which a computer program is stored. When the program is executed by a processor, it implements the steps of the method described in any of the foregoing method embodiments.

And an electronic device, comprising:
one or more processors; and
a memory associated with the one or more processors, the memory being used to store program instructions, the program instructions, when read and executed by the one or more processors, executing the steps of the method described in any of the foregoing method embodiments.

FIG. 9 exemplarily shows an architecture of an electronic device, which may specifically include a processor 910, a video display adapter 911, a disk drive 912, an input/output interface 913, a network interface 914, and a memory 920. The aforementioned processor 910, video display adapter 911, disk drive 912, input/output interface 913, network interface 914, and memory 920 may be communicatively connected via a communication bus 930.

The processor 910 may be implemented by using a general-purpose CPU (Central Processing Unit, processor), a microprocessor, an Application Specific Integrated Circuit (ASIC), or one or more integrated circuits, etc., and is configured to execute related programs to implement the technical solution provided by the present application.

The memory 920 may be implemented in the form of a Read Only Memory (ROM), a Random Access Memory (RAM), a static storage device, a dynamic storage device, or the like. The memory 920 may store an operating system 921 for controlling the operation of the electronic device 900, and a Basic Input/Output System (BIOS) for controlling low-level operations of the electronic device 900. In addition, it may also store a web browser 923, a data storage management system 924, a benefit information display processing system 925, and so on. The aforementioned benefit information display processing system 925 may be an application program that specifically implements the operations of the foregoing steps in the embodiments of the present application. In summary, when the technical solution provided by the present application is implemented by software or firmware, the relevant program code is saved in the memory 920 and is called and executed by the processor 910.

The input/output interface 913 is used to connect to an input/output module to implement information input and output. The input/output module can be configured as a component in the device (not shown in the figure), or can be externally connected to the device to provide corresponding functions. The input devices may include a keyboard, a mouse, a touchscreen, a microphone, various types of sensors, etc., and the output devices may include a display, a speaker, a vibrator, an indicator light, etc.

The network interface 914 is used to connect to a communication module (not shown in the figure) to implement communication interaction between this device and other devices. The communication module can implement communication through a wired method (e.g., USB, network cable, etc.), or through a wireless method (e.g., mobile network, WIFI, Bluetooth, etc.).

The bus 930 includes a channel for transmitting information between various components of the device (e.g., the processor 910, the video display adapter 911, the disk drive 912, the input/output interface 913, the network interface 914, and the memory 920).

It should be noted that, although the above device only shows the processor 910, the video display adapter 911, the disk drive 912, the input/output interface 913, the network interface 914, the memory 920, the bus 930, etc., in a specific implementation process, the device may also include other components necessary for normal operation. In addition, a person skilled in the art can understand that the above device may also include only the components necessary to implement the solution of the present application, and does not necessarily have to include all the components shown in the figure.

From the description of the above implementations, a person skilled in the art can clearly understand that the present application can be implemented by means of software plus a necessary general-purpose hardware platform. Based on this understanding, the technical solution of the present application in essence, or the part that contributes to the prior art, can be embodied in the form of a software product. The computer software product may be stored in a storage medium, such as a ROM/RAM, a magnetic disk, an optical disc, etc., and includes several instructions for causing a computer device (which may be a personal computer, a server, or a network device, etc.) to execute the methods described in various embodiments of the present application or some parts of the embodiments.

The various embodiments in this specification are described in a progressive manner. For the same or similar parts between the various embodiments, reference can be made to each other. Each embodiment focuses on the differences from other embodiments. In particular, for the system or system embodiments, since they are basically similar to the method embodiments, the description is relatively simple, and for related parts, reference can be made to the description of the method embodiments. The systems and system embodiments described above are merely schematic. The units described as separate components may or may not be physically separate. The components displayed as units may or may not be physical units, that is, they can be located in one place, or can be distributed over multiple network units. Some or all of the modules can be selected according to actual needs to achieve the purpose of the solution of this embodiment. A person of ordinary skill in the art can understand and implement it without creative efforts.

The method for displaying benefit information and the electronic device provided by the present application have been described in detail above. In this document, specific examples are used to explain the principles and implementations of the present application. The description of the above embodiments is only for helping to understand the method of the present application and its core ideas. At the same time, for a person of ordinary skill in the art, there will be changes in the specific implementations and application scope based on the ideas of the present application. In summary, the content of this specification should not be construed as a limitation on the present application.

1. A method for displaying benefit information comprising:
obtaining a benefit data definition template, the benefit data definition template including multiple data fields, the multiple data fields including data fields related to basic information and data fields related to user usage status;
obtaining, for multiple benefit items respectively under different user usage statuses, corresponding data display rule information on the data fields related to user usage status;
saving, according to the benefit data definition template, data on the multiple data fields of the multiple benefit items for a user, wherein the data on the data fields related to user usage status is determined based on the user's benefit item usage information and the data display rule information;
in response to a request from a target user to view benefit information, reading, from saved information, data of the target user on the multiple data fields of the multiple benefit items, and assembling the data into display content corresponding to each of the multiple benefit items, so as to display the display content corresponding to each of the multiple benefit items on a target page.

2. The method of claim 1, wherein,
for the data fields related to user usage status, different benefit items correspond to different candidate values on a same data field;
the data display rule information comprises: a correspondence relationship between each candidate value of a same benefit item on a same data field and a user usage status, so that based on user usage status information of a specific user, data to be displayed for a corresponding benefit item on a corresponding data field is determined from among candidate values of the corresponding benefit item on the corresponding data field.

3. The method of claim 2, wherein,
the data fields related to the user usage status comprise: a description text and/or an action item required to be displayed when displaying a benefit item;
the obtaining, for multiple benefit items respectively under different user usage statuses, corresponding data display rule information on the data fields related to user usage status, comprises:
obtaining description text and/or action item display rule information corresponding to multiple benefit items respectively under different user usage statuses; wherein each benefit item corresponds to a different candidate text and/or candidate action item, and the data display rule information comprises: a correspondence relationship between each candidate text and/or candidate action item of a same benefit item and a user usage status;
the saving, according to the benefit data definition template, data for a user on the multiple data fields of the multiple benefit items, comprises:
obtaining user usage status information of multiple users for the multiple benefit items respectively, and based on the user usage status information and the data display rule information, determining corresponding description text and/or action item to be displayed when displaying benefit items to each user, and saving the determined description text and/or action item as data on corresponding data fields.

4. The method of claim 3, wherein,
the action item includes a name and a jump address of an action item, so as to jump to a corresponding page according to the jump address to obtain detailed information related to a benefit item, or to perform processing related to the benefit item.

5. The method of claim 3, wherein,
if the target user has used a benefit item, the description text comprises: a number of times the target user has used the benefit item, a remaining number of times, and/or obtained usage effect information.

6. The method of claim 3, wherein,
if the target user has not used a benefit item, the description text comprises: summary information of a functional description of the benefit item.

7. The method of claim 1, further comprising,
by executing a scheduled task, obtaining user usage status information of multiple users for the multiple benefit items respectively, and based on the user usage status information and the data display rule information, determining, when displaying the benefit items to each user, data on the data fields related to user usage status.

8. The method of claim 1, wherein,
the benefit data definition template comprises: a first template and a second template, wherein the first template is used to define data fields of the benefit items related to basic information, and the second template is used to define data fields of the multiple benefit items related to user usage status;
the saving, according to the benefit data definition template, data on the multiple data fields of the multiple benefit items for a user, comprises:
according to the first template, saving data on the data fields of the multiple benefit items related to basic information as benefit configuration information;
according to the second template, saving data on the data fields of the multiple benefit items related to user usage status as benefit usage-related data information;
the, in response to a request from a target user to view benefit information, reading, from saved information, data of the target user on the multiple data fields of the multiple benefit items, and assembling the data into display content corresponding to each of the multiple benefit items, comprises:
obtaining, from the benefit configuration information, data of the multiple benefit items on the data fields related to basic information;
obtaining, from the benefit usage-related data, data of the target user for the multiple benefit items on the data fields related to user usage status;
assembling the data of the multiple benefit items on the data fields related to basic information and the data on the data fields related to user usage status to generate display content corresponding to each of the multiple benefit items.

9. The method of claim 8, wherein,
the obtaining, from the benefit configuration information, data of the multiple benefit items on the data fields related to basic information, comprises:
determining membership type information corresponding to the target user;
obtaining, from the benefit configuration information, data of multiple benefit items corresponding to the membership type on the data fields related to basic information.

10. The method of claim 9, wherein,
different membership types correspond to different processor modules;
after determining the membership type information corresponding to the target user, further comprising:
determining a corresponding processor module based on the membership type information, so that the processor module performs reading and assembling processing of the data.

11. The method of claim 8, wherein,
the benefit configuration information comprises a sort index field corresponding to the benefit items;
the method further comprises:
sorting the display content corresponding to the multiple benefit items according to data on the sort index field, so that the display content is displayed on the target page in a corresponding order.

12. A method for displaying benefit information, comprising:
receiving a request initiated by a target user to view benefit information;
displaying a target page, the target page comprising display content corresponding to each of a plurality of benefit items, wherein the display content is generated after a same processor module reads data of the target user on multiple data fields of the multiple benefit items and assembles the data;
wherein the data of the target user on the multiple data fields of the multiple benefit items is determined according to a benefit data definition template, which comprises data fields related to basic information and data fields related to user usage status, and the data on the data fields related to user usage status is determined based on benefit item usage status information of the user and data display rule information.

13. The method of claim 12, wherein,
for the data fields related to user usage status, different benefit items correspond to different candidate values on a same data field;
the data display rule information comprises: a correspondence relationship between each candidate value of a same benefit item on a same data field and a user usage status, so that based on user usage status information of a specific user, data to be displayed for a corresponding benefit item on a corresponding data field is determined from among candidate values of the corresponding benefit item on the corresponding data field.

14. The method of claim 13, wherein,
the data fields related to the user usage status comprise: a description text and/or an action item required to be displayed when displaying a benefit item.

15. The method of claim 14, wherein,
the action item includes a name and a jump address, so as to jump to a corresponding page according to the jump address to obtain detailed information related to a benefit item, or to perform processing related to the benefit item.

16. The method of claim 15, wherein,
if the target user has used a benefit item, the description text comprises: a number of times the target user has used the benefit item, a remaining number of times, and/or obtained usage effect information.

17. The method of claim 15, wherein,
if the target user has not used a benefit item, the description text comprises: summary information of a functional description of the benefit item.

18. The method of claim 12, wherein,
the benefit data definition template comprises: a first template and a second template, wherein the first template is used to define data fields of the benefit items related to basic information, and the second template is used to define data fields of the multiple benefit items related to user usage status.

19. The method of claim 12, wherein,
the same processor module corresponds to membership type information of the target user.

20. An electronic device comprising:
one or more processors; and
one or more computer-readable memories coupled to the one or more processors and having instructions stored thereon that are executable by the one or more processors to perform one or more operations comprising:
obtaining a benefit data definition template, the benefit data definition template including multiple data fields, the multiple data fields including data fields related to basic information and data fields related to user usage status;
obtaining, for multiple benefit items respectively under different user usage statuses, corresponding data display rule information on the data fields related to user usage status;
saving, according to the benefit data definition template, data on the multiple data fields of the multiple benefit items for a user, wherein the data on the data fields related to user usage status is determined based on the user's benefit item usage information and the data display rule information;
in response to a request from a target user to view benefit information, reading, from saved information, data of the target user on the multiple data fields of the multiple benefit items, and assembling the data into display content corresponding to each of the multiple benefit items, so as to display the display content corresponding to each of the multiple benefit items on a target page.
